(19) United States
(12) Patent Application Publication
(10) Pub. No.: US 2013/0034802 A1
(43) Pub. Date: Feb. 7, 2013

(54) SOLID OXIDE FUEL CELL AND MANUFACTURING METHOD THEREOF

(71) Applicants: Hyun SOH, Yongin-si (KR); Ho-Jin KWEON, Yongin-si (KR)

(72) Inventors: Hyun SOH, Yongin-si (KR); Ho-Jin KWEON, Yongin-si (KR)

(73) Assignee: Samsung SDI Co., Ltd., Yongin-si (KR)

(21) Appl. No.: 13/446,782

(22) Filed: Apr. 13, 2012

(30) Foreign Application Priority Data
Aug. 5, 2011 (KR) 10-2011-0078354

(51) Int. Cl. H01M 4/86; H01M 8/00; H01M 4/66

(52) U.S. Cl. 429/519; 429/523; 429/535

(57) ABSTRACT

A solid oxide fuel cell and a manufacturing method thereof are disclosed. A solid oxide fuel cell includes first and second electrode formed opposite to each other and an electrolyte layer formed between the first and the second electrodes. Either the first electrode or the second electrode may include between about 1 to about 20 wt % of a thermoelectronic material configured to increase thermal emission of electrons with an increase in temperature.

### CROSS-REFERENCE TO RELATED APPLICATIONS

This application claims priority to and the benefit of Korean Patent Application No. 10-2011-0078354, filed on Aug. 5, 2011, in the Korean Intellectual Property Office, the entire content of which is incorporated herein by reference.

### BACKGROUND

1. Field of the Disclosure

The present disclosure relates to a solid oxide fuel cell and a manufacturing method thereof. The present disclosure also relates to a solid oxide fuel cell with improved fuel cell performance.

2. Description of the Related Technology

A solid oxide fuel cell has a high operating temperature of 800 to 1000° C. and relatively high energy conversion efficiency. The solid oxide fuel cell is composed of unit cells, each unit cell having a sequentially laminated anode, electrolyte layer and cathode and a bundle or stack for binding the unit cells. Yttria stabilized zirconia (YSZ) is generally used as a material of the electrolyte layer. LSM (LaSrMnO₃) that is a perovskite-type oxide is used as a material of the cathode, and a metal ceramic complex (cermet) such as NiO—(YSZ)₈ or Ni—(YSZ)₈ is used as an anode material. Here, the metal ceramic complex (cermet) is relatively inexpensive and is relatively stabile under a high-temperature reduction atmosphere.

Studies have been conducted to improve efficiency of the unit cell by changing the material used for each of the cathode, the electrolyte layer and the anode, which constitute the unit cell of the fuel cell. Particular study has been made to observe an electrode phenomenon that may occur at a boundary between the elements of the unit cell.

### SUMMARY OF CERTAIN INVENTIVE ASPECTS

In a first aspect, a solid oxide fuel cell and a manufacturing method thereof are provided, which can improve current generation efficiency of the fuel cell by activating an electrode reaction occurring in an electrode, current collector or support in which an electrode phenomenon is actively generated.

In another aspect, a solid oxide fuel cell includes, for example, first and second electrodes formed opposite to each other, and an electrolyte layer formed between the first and second electrodes.

In some embodiments, at least one of the first and second electrodes is formed of a thermoelectronic material configured to increase thermal emission of electrons with an increase in temperature. In some embodiments, the thermoelectronic material is between about 1 to about 20 wt % of the at least one of the first and second electrodes. In some embodiments, a current collector configured for current collection is electrically connected to the first or the second electrode. In some embodiments, the current collector is formed of between about 1 to about 20 wt % of a thermoelectronic material configured to increase thermal emission of electrons with an increase in temperature. In some embodiments, a support is formed inside of either the first electrode or the second electrode. In some embodiments, the support is formed of between about 1 to about 20 wt % of a thermoelectronic material configured to increase thermal emission of electrons with an increase in temperature. In some embodiments, the thermoelectronic material is formed of at least one alkaline earth metal. In some embodiments, the thermoelectronic material is formed of at least one lanthanide. In some embodiments, the thermoelectronic material is formed of tungsten or tungsten alloy.

In another aspect, a method of manufacturing a solid oxide fuel cell includes, for example, providing an electrolyte layer, forming a first electrode on a first side of the electrolyte layer, and forming a second electrode on a second side of the electrolyte layer.

In some embodiments, at least one of the first electrode and the second electrode is formed of a thermoelectronic material configured to increase thermal emission of electrons with an increase in temperature. In some embodiments, the thermoelectronic material is between about 1 to about 20 wt % of the at least one of the first electrode and the second electrode. In some embodiments, the method further includes electrically connecting a current collector to the first electrode or the second electrode. In some embodiments, the current collector comprises between about 1 to about 20 wt % of a thermoelectronic material configured to increase thermal emission of electrons with an increase in temperature. In some embodiments, the method further includes forming a support inside of the first electrode or the second electrode. In some embodiments, the support is formed of between about 1 to about 20 wt % of a thermoelectronic material configured to increase thermal emission of electrons with an increase in temperature.

### BRIEF DESCRIPTION OF THE DRAWINGS

Features of the present disclosure will become more fully apparent from the following description and appended claims, taken in conjunction with the accompanying drawings. It will be understood these drawings depict only certain embodiments in accordance with the disclosure and, therefore, are not to be considered limiting of its scope; the disclosure will be described with additional specificity and detail through use of the accompanying drawings. An apparatus, system or method according to some of the described embodiments can have several aspects, no single one of which necessarily is solely responsible for the desirable attributes of the apparatus, system or method. After considering this discussion, and particularly after reading the section entitled “Detailed Description of Certain Inventive Embodiments” one will understand how illustrated features serve to explain certain principles of the present disclosure.

FIG. 1 is a cross-sectional view schematically showing a unit cell of a solid oxide fuel cell according to an embodiment of the present disclosure.

FIG. 2 is a graph showing a correlation between an operating time of the fuel cell and a continuous density of thermoelectrons emitted from a thermoelectronic material according to the embodiment illustrated in FIG. 1.

FIG. 3 is a graph showing a correlation between a composition range of the thermoelectronic material and a degree of increase in power of the fuel cell according to the embodiment illustrated in FIG. 1.

FIG. 4 is a flowchart illustrating a manufacturing process of a unit cell according to an embodiment of the present disclosure.

### DETAILED DESCRIPTION OF CERTAIN INVENTIVE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements. In the drawings, the thickness or size of layers are exaggerated for clarity and not necessarily drawn to scale.

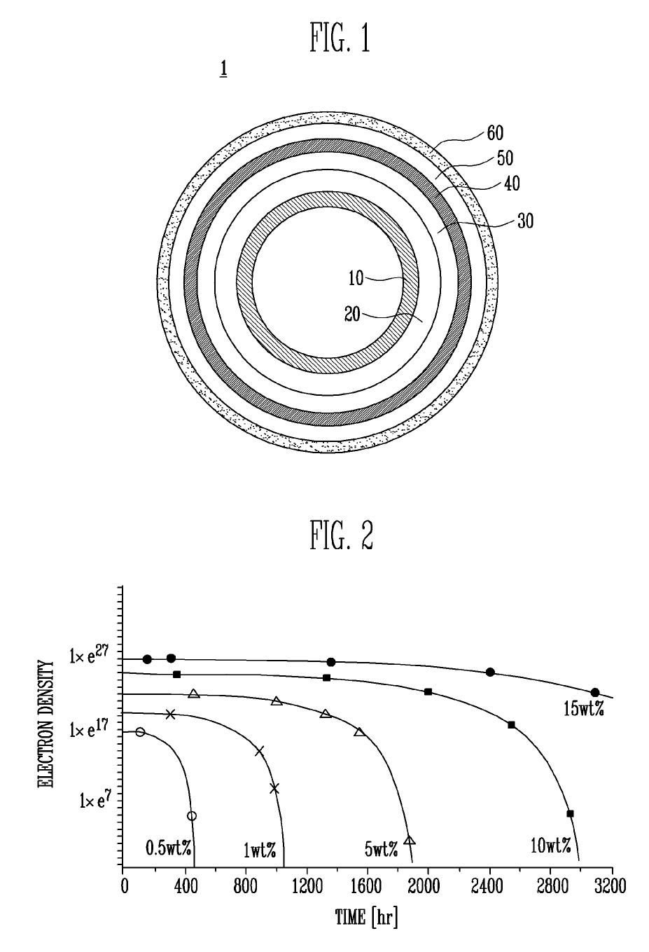

Hereinafter, a unit cell of a solid oxide fuel cell including a thermoelectronic material according to an embodiment of the present disclosure will be described with reference to FIGS. 1 to 3.

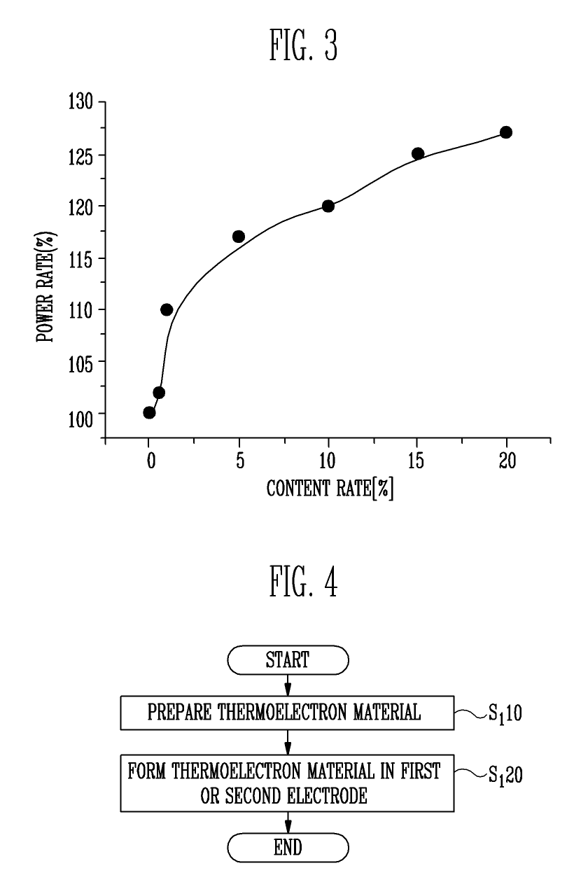

FIG. 1 is a cross-sectional view schematically showing a unit cell of a solid oxide fuel cell according to an embodiment of the present disclosure. FIG. 2 is a graph showing a correlation between an operating time of the fuel cell and a continuous density of thermoelectrons emitted from a thermoelectronic material according to the embodiment illustrated in FIG. 1. FIG. 3 is a graph showing a correlation between a composition range of the thermoelectronic material and a degree of increase in power of the fuel cell according to the embodiment illustrated in FIG. 1.

Referring to FIG. 1, the unit cell 1 of the solid oxide fuel cell has a hollow pipe structure formed by sequentially laminating a first current collector 20, a first electrode 30, an electrolyte layer 40, a second electrode 50, and a second current collector 60, which have a cylindrical shape. For example, in a case where the first electrode 30 is an anode and the second electrode 50 is a cathode, the unit cell 1 may be configured to generate electricity through an electrochemical reaction between hydrogen and oxygen respectively supplied from the first and second electrodes 30 and 50. Here, the first current collector 20 is formed on the inner circumferential surface of the first electrode 30, and the second current collector 60 is formed on the outer circumferential surface of the second electrode 50. Thus, the electricity generated from the unit cell 1 may be supplied to an external device or circuit through the first and second current collectors 20 and 60. In this instance, the second current collector 60 is generally formed in the shape of a wire spirally wound around the outer circumferential surface of the second electrode 50.

The first current electrode 20 may be formed of various types of metal materials including a wire, a stick, a metal pipe and a tube. The first current electrode 20 may be formed on the inner circumferential surface of the first electrode 30. The metal materials including a wire, a stick, a metal pipe and a tube may be inserted into the first electrode 30 and be configured both to perform current collection of the first electrode 30 and to improve the strength of the fuel cell.

As shown in FIG. 1, the first current collector 20 may be adhered and fixed to the inner circumferential surface of the first electrode 30 by a metal tube 10 formed in the inside of the first electrode 30.

Meanwhile, as shown in FIG. 1, the first electrode 30 has a hollow configured to pass fuel therethrough, and configured to serve as a support for the unit cell 1.

The second electrode 50 is formed opposite to the first electrode 30 with the electrolyte layer 40 interposed therebetween. The unit cell 1 according to this embodiment has a structure in which air is supplied to the outer circumferential surface of the second electrode 50. The electrolyte layer 40 is formed between the first and second electrodes 30 and 50. The electrolyte layer 40 may be formed into a structure having high ion conductivity under oxidation and reduction atmospheres and chemical and physical stability. The electrolyte layer 40 is preferably formed as thin as possible.

In operation of the unit cell 1, air supplied from the outside of the unit cell 1 may be converted into oxygen ions in the second electrode 50, and the converted oxygen ions are then diffused through the electrolyte layer 40 so as to react with the fuel of the first electrode 30. Thereafter, current generated from the first electrode 30 moves outside of the unit cell through the first current collector 20.

According to this embodiment, the first or second electrode 30 or 50 of the unit cell 1 contains a thermoelectronic material configured to increase thermal emission of electrons with an increase in the temperature of the thermoelectronic material. Here, the thermoelectronic material is preferably contained in the first or second electrode 30 or 50 in a composition range from about 1 to about 20 wt % with respect to the entire composition of the first or second electrode 30 or 50.

The “thermoelectron emission phenomenon” is a phenomenon wherein electrons are emitted from a surface of a metal or metal oxide semiconductor heated to a high temperature. In the thermoelectron emission phenomenon, electrons are excited by heat. The electrons are then separated and emitted from a surface of a solid by overcoming the electrostatic force bonding the electrons by means of vibration energy. The thermoelectron emission phenomenon may be applied to a vacuum tube, a discharge tube, and the like. To eject electrons from a certain metal, energy corresponding to a minimum work function (bonding energy) is applied to the metal. Electrons ejected from a surface of the metal by heat have a negative (−) charge. Therefore, if a positive (+) electrode is connected to the opposite side of the metal, the electrons are moved by an electric force.

$$J = {AT}^{2} {e}^{- \frac{φ}{kT}}$$

Here, ‘J’ denotes current density, ‘A’ denotes a constant, ‘T’ denotes an absolute temperature (K) of metal, ‘e’ denotes a natural logarithm, ‘k’ denotes a Boltzmann constant (1.38×10⁻²³ J/K), and ‘φ’ denotes a work function.

To increase the current generated using the thermoelectron emission phenomenon, a metal material with a small work function or a metal material with a high melting point is used, or the absolute temperature is increased.

According to the embodiment illustrated in FIG. 1, the thermoelectronic material satisfying the condition may be at least one selected from the group including beryllium (Be), magnesium (Mg), calcium (Ca), strontium (Sr), barium (Ba) and radium (Ra), which are alkaline earth metals. The alkaline earth metals have a characteristic in that thermoelectrons may be actively emitted at a low temperature as compared with other metals. The thermoelectronic material may be selected from the group including lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), Ytterbium (Yb) and lutetium (Lu), which are lanthanides. The lanthanides are elements of the periodic system with atom number 57 to 73, and have a characteristic in that emission of free electrons are accelerated according to an increase in temperature. Tungsten (W) or tungsten alloy may be used as the thermoelectronic material. Here, the tungsten or tungsten alloy is a transition metal having a high melting point and excellent thermoelectron emission efficiency.

According to the embodiment illustrated in FIG. 1, the thermoelectronic material may be contained in the first or second electrode 30 or 50, so that during operation the thermal emission of electrons can be increased according to an increase in temperature in driving of the unit cell 1. Accordingly, electrons can be more easily moved in the first or second electrode 30 or 50. Further, electrons and oxygen are combined by forming the thermoelectronic material, so that the amount of oxygen ions can be increased. Accordingly, the entire output performance of the unit cell 1 can be improved.

Here, the thermoelectronic material is preferably mixed into the first or second electrode 30 or 50 in a composition range from about 1 to about 20 wt % with respect to the entire composition of the first or second electrode 30 or 50. The composition range is a result derived from a suitable composition range by synthesizing a correlation between the operating time (hr) of the fuel cell and the continuous density of thermoelectrons emitted from the thermoelectronic material and a degree of increase in power of the fuel cell based on the composition range of the thermoelectronic material.

Referring to FIG. 2, the suitable composition range of the thermoelectronic material can be obtained through the correlation between the operating time of the fuel cell and the continuous density of thermoelectrons emitted from the thermoelectronic material.

As an example, the time at which the density of thermoelectrons emitted from the thermoelectronic material is continued can be obtained by calculating the density of the emitted thermoelectrons as a ratio of the mass of the thermoelectronic material to the content of the thermoelectronic material contained in the first or second electrode 30 or 50. If the fuel cell operates for about 1000 hours, (which may be a preferable operating time in terms of efficiency of the solid oxide fuel cell), the content of the thermoelectronic material contained in the first or second electrode 30 or 50 is at least about 1 wt % or higher with respect to the entire composition of the first or second electrode 30 or 50. If the content of the thermoelectronic material is about 5 wt %, the fuel cell can operate for about 1800 hours. If the content of the thermoelectronic material is about 10 wt %, the fuel cell can operate for about 2800 hours. If the content of the thermoelectronic material is about 15 wt %, the fuel cell can operate for about 3200 hours. Although not shown in this figure, if the content of the thermoelectronic material is about 15 wt % or higher, the operating time of the fuel cell will be increased as compared with when the content of the thermoelectronic material is less than about 15 wt %. As another example, if the content of the thermoelectronic material is about 0.5 wt %, the thermal emission of electrons can be continued until an operating time of about 400 hours. However, since the operating time of about 400 hours does not approach about 1000 hours that is a preferable operating time, the addition of about 0.5 wt % thermoelectronic material belongs to the composition range which effect was unexpected when adding the thermoelectronic material to the first or second electrode 30 or 50.

FIG. 3 illustrates a correlation between a composition range of the thermoelectronic material and a degree of increase in power of the fuel cell (power rate, %). In other words, there can be seen a degree of increase in the power of the fuel cell, depending on the content of the thermoelectronic material when the thermoelectronic material is added to the first or second electrode 30 or 50.

The thermoelectronic material may have an effect of slightly increasing the power of the fuel cell by adding, to the first or second electrode 30 or 50, the thermoelectronic material of which content is a small amount of less than about 1 wt % with respect to the entire composition of the first or second electrode 30 or 50, but the effect is insignificant. If the content of the thermoelectronic material is about 1 wt %, the power rate of the fuel cell can be increased by about 5%. Thereafter, the power rate of the fuel cell is increased by about 15% until the time when the content of the thermoelectronic material is about 5 wt %. If the content of the thermoelectronic material is about 20 wt %, the power rate of the fuel cell can be increased by about 27%. Although not shown in this figure, if the content of the thermoelectronic material is about 20 wt % or higher, the power rate of the fuel cell is increased as compared with when the content of the thermoelectronic material is less than about 20 wt %.

Referring to FIGS. 2 and 3, as described above, although the content of the thermoelectronic material is about 15 wt % or higher with respect to the entire composition of the first or second electrode 30 or 50, the operating time of the fuel cell will be increased (see FIG. 2). As described above, although the content of the thermoelectronic material is about 20 wt % or higher, the power rate of the fuel cell will be more increased. When considering the continuous operation durability of an actual fuel cell and the decrease amount of an electrode material caused by adding the thermoelectronic material to the electrode material, however, the thermoelectronic material is preferably mixed into the first or second electrode 30 or 50 in a composition range from about 1 to about 20 wt % with respect to the entire composition of the first or second electrode 30 or 50.

Although it has been described in this embodiment that the thermoelectronic material is contained in the first or second electrode 30 or 50, the present disclosure is not limited thereto. For example, the thermoelectronic material may be contained in the first or second current collector 20 or 60. In this case, the thermoelectronic material may be contained in the first or second current collector 20 or 60 in a composition range from about 1 to about 20 wt % with respect to the entire composition of the first or second current collector 20 or 60. The thermoelectronic material may be contained in the metal tube 10 that becomes a support of the unit cell 1. In this case, the thermoelectronic material may also be contained in the metal tube 10 in a composition range from about 1 to about 20 wt % with respect to the entire composition of the metal tube 10. In both the two cases, the thermal emission of electrons can be increased according to an increase in temperature in the driving of the unit cell, and thus electrons will be easily moved. Accordingly, the entire power performance of the unit cell 1 can be more improved.

Hereinafter, a manufacturing process of a unit cell of a solid oxide fuel cell containing a thermoelectronic material according to an embodiment of the present disclosure will be described with reference to FIGS. 1 to 4.

FIG. 1 is a cross-sectional view schematically showing a unit cell of a solid oxide fuel cell according to the embodiment of the present disclosure. FIG. 4 is a flowchart illustrating a manufacturing process of a unit cell according to an embodiment of the present disclosure. The unit cell manufactured according to this embodiment is the unit cell 1 shown in FIG. 1. The unit cell is manufactured as an anode-supported fuel cell having a cylindrical structure. Therefore, the manufacturing process of the unit cell 1 may be changed depending on the kind of the unit cell 1.

Referring to FIG. 4, a thermoelectronic material is first prepared (S₁10). Then, the thermoelectronic material is contained in the first or second electrode 30 or 50 of the unit cell 1 (S₁20). In the thermoelectronic material, the thermal emission of electrons may be increased with an increase in temperature. Specifically, the thermoelectronic material is mixed into a metal ceramic complex such as YSZ, NiO—(YSZ)₈ or Ni—(YSZ)₈ in a composition range from about 1 to about 20 wt % with respect to the entire composition of the first or second electrode 30 or 50, and the mixture is then fired, thereby forming the first electrode 30 containing the thermoelectronic material.

The thermoelectronic material is mixed into a pure electron conductor or mixed conductor with excellent electron conductivity, such as silver, LaMnO₃, LaCoO₃ or LSM (LaSrMnO₃), in a composition range from about 1 to about 20 wt %, and the mixture is then fired, thereby forming the second electrode 50 containing the thermoelectronic material.

As mentioned above, the “thermoelectron emission phenomenon” is a phenomenon wherein electrons are emitted from a surface of a metal or metal oxide semiconductor heated to a high temperature. In the thermoelectron emission phenomenon, electrons excited by heat are separated and emitted from a surface of a solid by overcoming the electrostatic force bonding the electrons by means of vibration energy. The thermoelectron emission phenomenon may be applied to a vacuum tube, a discharge tube, and the like. To increase the current generated using the thermoelectron emission phenomenon, a metal material with a small work function or a metal material with a high melting point is used, or the absolute temperature is increased.

According to this embodiment, the thermoelectronic material is contained in the first or second electrode 30 or 50, so that in operation of the unit cell the thermal emission of electrons can be increased with an increase in temperature in driving of the unit cell 1. Accordingly, electrons can be easily moved in the first or second electrode 30 or 50. Further, electrons and oxygen are combined with each other by forming the thermoelectronic material, so that the amount of oxygen ions can be increased. Accordingly, the entire output performance of the unit cell 1 can be improved.

Although it has been described in this embodiment that the thermoelectronic material is contained in the first or second electrode 30 or 50, the present disclosure is not limited thereto. For example, the thermoelectronic material may be contained in the first or second current collector 20 or 60. In this case, the thermoelectronic material is preferably contained in the first or second current collector 20 or 60 in a composition range from about 1 to about 20 wt % with respect to the entire composition of the first or second current collector 20 or 60. The thermoelectronic material may be contained in the metal tube 10 that becomes a support of the unit cell 1. In this case, the thermoelectronic material is preferably contained in the metal tube 10 in a composition range from about 1 to about 20 wt % with respect to the entire composition of the metal tube 10. In both the two cases, during operation the thermal emission of electrons can be increased with an increase in temperature in the driving of the unit cell, and thus, electrons will be easily moved. Accordingly, the entire power performance of the unit cell 1 can be more improved.

The first electrode, the second electrode, the current collector, or the support of any of the above-described embodiments may be formed of less than, equal to, greater than or between any amount of thermoelectronic material from 1, 2, 3, 4, 5, 6, 7, 8, 9, 10, 11, 12, 13, 14, 15, 16, 17, 18, 19 or 20 wt %.

Although it has been described in this embodiment that the thermoelectronic material is contained in the electrode, current collector or support, the structure of the unit cell according to this embodiment is not limited thereto. For example, the thermoelectronic material may be coated on the surface of the electrode, current collector or support using a patterning or deposition method.

Although the unit cell according to this embodiment is an anode-supported fuel cell using the first electrode that is an anode as a support, the structure of the unit cell is not limited thereto. A pipe structure having various sectional shapes may be used as another embodiment of the unit cell. For example, certain acceptable embodiments include square or rectangular shapes as well as cylindrical shapes of a pipe structure.

While the present invention has been described in connection with certain exemplary embodiments, it will be appreciated by those skilled in the art that various modifications and changes may be made without departing from the scope of the present disclosure. It should be understood that the exemplary embodiments described therein should be considered in a descriptive sense only and not for purposes of limitation. Descriptions of features or aspects within each embodiment should typically be considered as available for other similar features or aspects in other embodiments. Indeed, it will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. Thus, while the present disclosure has described certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A solid oxide fuel cell, comprising:
first and second electrodes formed opposite to each other; and
an electrolyte layer formed between the first and second electrodes,
wherein at least one of the first and second electrodes is formed of a thermoelectronic material configured to increase thermal emission of electrons with an increase in temperature, and wherein the thermoelectronic material is between about 1 to about 20 wt % of the at least one of the first and second electrodes.

2. The solid oxide fuel cell of claim 1, wherein a current collector configured for current collection is electrically connected to the first or the second electrode, and wherein the current collector is formed of between about 1 to about 20 wt % of a thermoelectronic material configured to increase thermal emission of electrons with an increase in temperature.

3. The solid oxide fuel cell of claim 1, wherein a support is formed inside of either the first electrode or the second electrode, and wherein the support is formed of between about 1 to about 20 wt % of a thermoelectronic material configured to increase thermal emission of electrons with an increase in temperature.

4. The solid oxide fuel cell of claim 1, wherein the thermoelectronic material is formed of at least one alkaline earth metal.

5. The solid oxide fuel cell of claim 1, wherein the thermoelectronic material is formed of at least one lanthanide.

6. The solid oxide fuel cell of claim 1, wherein the thermoelectronic material is formed of tungsten or tungsten alloy.

7. A method of manufacturing a solid oxide fuel cell, comprising:
providing an electrolyte layer;
forming a first electrode on a first side of the electrolyte layer; and
forming a second electrode on a second side of the electrolyte layer, wherein at least one of the first electrode and the second electrode is formed of a thermoelectronic material configured to increase thermal emission of electrons with an increase in temperature, and wherein the thermoelectronic material is between about 1 to about 20 wt % of the at least one of the first electrode and the second electrode.

8. The method of claim 7 further comprising electrically connecting a current collector to the first electrode or the second electrode, wherein the current collector comprises between about 1 to about 20 wt % of a thermoelectronic material configured to increase thermal emission of electrons with an increase in temperature.

9. The method of claim 7 further comprising forming a support inside of the first electrode or the second electrode, wherein the support is formed of between about 1 to about 20 wt % of a thermoelectronic material configured to increase thermal emission of electrons with an increase in temperature.
